(19) United States
(12) Patent Application Publication
(10) Pub. No.: US 2026/0233702 A1
(43) Pub. Date: Aug. 13, 2026

(54) VEHICLE SYSTEM AND CONTROL METHOD OF VEHICLE SYSTEM

(71) Applicant: DENSO CORPORATION, Kariya-shi (JP)

(72) Inventors: Sho MATSUMOTO, Kariya-shi (JP); Tomohisa KISHIGAMI, Kariya-shi (JP); Eiichiro KAWAKAMI, Kariya-shi (JP); Youichi HAYASE, Kariya-shi (JP)

(21) Appl. No.: 19/534,078

(22) Filed: Feb. 9, 2026

(30) Foreign Application Priority Data
Feb. 12, 2025 (JP) 2025-021026

(51) Int. Cl. B60R 25/24; H04L 67/12

(52) U.S. Cl. CPC B60R 25/24; H04L 67/12

(57) ABSTRACT

A vehicle system includes a management target control device configured to be activated and switched to an operable state when a first activation condition being satisfied. The vehicle system further includes a management target device including at least one of an actuator or a sensor. The management target device is configured to be activated when a second activation condition being satisfied. The second activation condition is set to be different from the first activation condition. The actuator is configured to operate according to an instruction from the management target control device. The sensor is configured to provide a sensor signal necessary for a control process to be executed by the management target control device. The management target control device and the management target device operate in cooperative manner to allow a user to board a vehicle or to operate the vehicle.

### CROSS REFERENCE TO RELATED APPLICATIONS

The present application claims the benefit of priority from Japanese Patent Application No. 2025-021026 filed on February 12, 2025. The entire disclosure of the above application is incorporated herein by reference.

### TECHNICAL FIELD

The present disclosure relates to a vehicle system and a control method of a vehicle system, which can improve security performance of a vehicle.

### BACKGROUND

Conventionally, a vehicle security system can immobilize a vehicle when a vehicle theft occurs and disable a function of communication device mounted on the vehicle.

When the communication device mounted on the vehicle is functioning, the communication device can communicate wirelessly with an external device, such as a center device to report vehicle theft or activate vehicle tracking function based on vehicle position information. After the vehicle theft is occurred, if the communication device is removed from the vehicle to disable the communication function, it is impossible to implement anti-theft operation using wireless communication of the communication device.

### SUMMARY

According to an aspect of the present disclosure, a vehicle system includes a management target control device configured to be activated and switched to an operable state in response to a first activation condition being satisfied. The vehicle system further includes a management target device including at least one of an actuator or a sensor. The management target device is configured to be activated in response to a second activation condition being satisfied. The second activation condition may be set to be different from the first activation condition. The actuator is configured to operate in response to an instruction from the management target control device. The sensor is configured to provide a sensor signal necessary for a control process to be executed by the management target control device. The management target control device and the management target device operate in cooperative manner to allow a user to board a vehicle or to operate the vehicle.

### BRIEF DESCRIPTION OF DRAWINGS

The present disclosure will become apparent from the following detailed description made with reference to the accompanying drawings. In the drawings:

FIG. 1 is a diagram showing an example of an overall configuration of a security system including a vehicle system according to an embodiment of the present disclosure;

FIG. 2 is a diagram illustrating an example of a configuration of a vehicle system according to an embodiment of the present disclosure;

FIG. 3 is a diagram showing examples of an NM message, PN request information, and PNC setting information;

FIG. 4A and FIG. 4B are diagrams respectively showing examples of a PNC setting table;

FIG. 5 is a flowchart showing a process executed by an upper layer ECU;

FIG. 6 is a flowchart showing a process executed by an upper layer ECU for switching between a normal mode and a security mode;

FIG. 7 is a flowchart showing a process executed by an intermediate layer ECU located in an upper layer than a lower layer ECU that is activated in response to a first activation condition being satisfied;

FIG. 8 is a flowchart showing a process executed by an intermediate layer ECU located in an upper layer than an actuator and/or sensor that is activated in response to a second activation condition being satisfied;

FIG. 9 is a flowchart showing a process executed by an upper layer ECU in a vehicle system according to a second embodiment of the present disclosure;

FIG. 10 is a flowchart showing a process executed by an upper layer ECU in a vehicle system according to a third embodiment of the present disclosure;

FIG. 11 is a flowchart showing a process executed by a first intermediate layer ECU in the vehicle system according to the third embodiment of the present disclosure;

FIG. 12 is a flowchart showing a process executed by a second and a third intermediate layer ECUs in the vehicle system according to the third embodiment of the present disclosure;

FIG. 13 is a diagram showing an exemplary configuration of a vehicle system according to a fourth embodiment of the present disclosure;

FIG. 14 is a flowchart showing a process executed by first to third lower layer ECUs in the vehicle system according to the fourth embodiment of the present disclosure; and

FIG. 15 is a flowchart showing a process executed by processing units of the first and second actuators or sensors in the vehicle system according to the fourth embodiment.

### DETAILED DESCRIPTION

As described above, a vehicle security system in a related art includes a communication device that communicates wirelessly with an external device, a drive control device that controls a drive device of the vehicle, and an anti-theft device that restricts an operation of the drive control device in the event of vehicle theft. The anti-theft device is configured to communicate with the communication device and the drive control device. When the anti-theft device receives an activation request of the vehicle drive device, the anti-theft device communicates with the communication device. When the communication with the communication device is not possible, the anti-theft device restricts the operation of drive control device to disable activation of vehicle drive device.

The above-described vehicle security system takes a measure in the event of vehicle theft, and the communication device is removed from the vehicle. However, it is difficult to prevent a vehicle theft using relay attack with the above-described vehicle security system.

According to an aspect of the present disclosure, a vehicle system includes a management target control device configured to be activated and switched to an operable state in response to a first activation condition being satisfied. The vehicle system further includes a management target device including at least one of an actuator or a sensor. The management target device is configured to be activated in response to a second activation condition being satisfied. The second activation condition is set to be different from the first activation condition. The actuator is configured to operate in response to an instruction from the management target control device. The sensor is configured to provide a sensor signal necessary for a control process to be executed by the management target control device. The management target control device and the management target device operate in cooperative manner to allow a user to board a vehicle or to operate the vehicle.

According to another aspect of the present disclosure, a control method of a vehicle system includes: activating a management target control device and switching the management target control device to an operable state, in response to a first activation condition being satisfied; and activating a management target device, which includes at least one of an actuator or a sensor, in response to a second activation condition being satisfied. The second activation condition is set to be different from the first activation condition. The actuator is configured to operate in response to an instruction from the management target control device, and the sensor is configured to provide a sensor signal necessary for a control process to be executed by the management target control device. The management target control device and the management target device operate in cooperative manner to allow a user to board a vehicle or to operate the vehicle.

In the vehicle system and the control method of vehicle system according to the present disclosure, the management target control device, the actuator that operates in accordance with the instruction from the management target control device, and/or the sensor that provides the sensor signal necessary for the control process to be executed by the management target control device need to work together when the user boards the vehicle or drives the vehicle. Therefore, unless the management target control device, the actuator, and/or the sensor are operating in cooperative manner, it becomes difficult for the user to board or drive the vehicle. This also applies to a third party who attempts to steal the vehicle.

In the vehicle system and the control method of vehicle system according to the present disclosure, the management target control device is activated and switched to an operable state when the first activation condition is satisfied. The management target device, that is, the actuator and/or sensor is activated when the second activation condition, which is set to be different from the first activation condition, is satisfied. By differentiating the activation condition of the management target control device from the activation condition of the management target device, it is possible to restrict a third party from attempting to steal the vehicle by making it difficult for operating both the management target control device and the management target device together. As a result, theft of vehicle becomes more difficult, and vehicle security performance can be effectively improved by avoiding the vehicle theft itself.

Hereinafter, embodiments of a vehicle system and a control method of the vehicle system according to the present disclosure will be described with reference to the drawings. The present disclosure is not limited to the following embodiments, and various modifications described below are also included in the technical scope of the present disclosure. In addition to the following embodiments, various modifications can be made without departing from the spirit of the present disclosure. The embodiments and various modification examples can be combined as appropriate within the scope of the present disclosure without causing any technical contradiction. In the following description, the same or similar components may be denoted by the same reference symbols throughout the drawings, and the description thereof may be omitted. When only a part of the configuration is described, the explanations given elsewhere can be applied to the remaining parts.

### First Embodiment

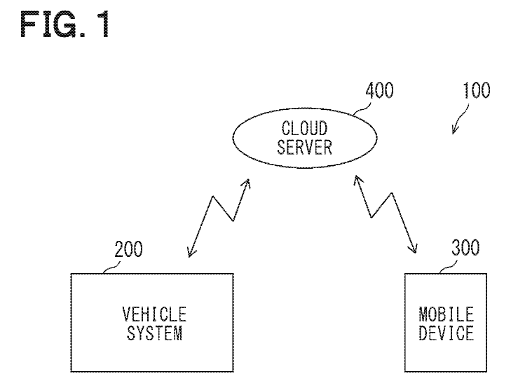

FIG. 1 shows an overall configuration of a security system 100, which includes a vehicle system 200 according to the present embodiment. The security system 100 includes the vehicle system 200, a mobile device 300 carried by a user, and a cloud server 400. For example, when the vehicle system 200 and the mobile device 300 are capable of performing wireless communication, such as Bluetooth (registered trademark) communication or near field communication (NFC) without going through the cloud server 400, the cloud server 400 may be omitted.

The vehicle system 200 includes multiple electronic control units (hereinafter referred to as ECUs), actuators that operate according to instructions from the ECUs, and/or sensors that provide sensor signals necessary for the control processes to be executed by the ECUs. In the present embodiment, when the vehicle system 200 switches to a security mode, a condition for activating the ECU (first activation condition) is set to be different from a condition for activating the actuator and/or sensor (second activation condition) for the ECU and the actuator and/or sensor that operate in cooperative manner. The security modes will be explained in more detail below. The ECU, actuator and/or sensor that operate in cooperative manner are utilized to allow a user to enter the vehicle and/or to operate the vehicle.

As an example of an ECU and actuator and/or sensor operating in cooperative manner to allow a user to enter a vehicle, the actuator may be a door lock motor that locks or unlocks a vehicle door, and the sensor may be a touch sensor that detects a touch operation performed by a user on a door handle of the vehicle door. The ECU can function as a door ECU that controls an operation of the door lock motor in response to the user’s touch operation detected by the touch sensor, and switches the door state between locking state and unlocking state. In this configuration, under a condition that the door ECU, the door lock motor, and the touch sensor operate in cooperative manner, the user can board the vehicle. It should be noted that only the actuator (door lock motor) or only the sensor (touch sensor) may be activated in response to the second activation condition being satisfied. That is, the other of the actuator and the sensor may be activated regardless of whether the second activation condition is satisfied or not.

As an example of the ECU and actuator and/or sensor operating in cooperative manner to control traveling of the vehicle, the actuator may be a starter motor for starting the engine, and the sensor may be a switch sensor that detects turn-on operation of the vehicle's start switch. The ECU may be an engine ECU that drives the starter motor to start the engine in response to the switch sensor detecting turn-on of the start switch. In this configuration, under a condition that the engine ECU, the starter motor, and the switch sensor operate in cooperative manner, the user can start the engine, that is, can start traveling of the vehicle.

In another example where the ECU and actuator and/or sensor operating in cooperative manner to drive the vehicle, the actuator may be a fuel injection device or an ignition device for driving the engine, and the sensor may be an accelerator sensor that detects a depression amount of an accelerator pedal. The ECU may be an engine ECU that instructs the fuel injection device about fuel injection amount or instructs the ignition device about an ignition timing based on the depression amount of the accelerator pedal detected by the accelerator sensor. In this configuration, under a condition that the engine ECU, actuators such as the fuel injection device and ignition device, and accelerator sensor operate in cooperative manner, the user can control the driving of vehicle. In the two examples described above, it may be configured that only the actuator (starter motor, fuel injection device, ignition device) or only the sensor (switch sensor, accelerator sensor) may be activated when the second activation condition is satisfied.

The above examples are merely illustrative examples. For example, when the driving power source of the vehicle is an electric motor rather than an engine, the actuator may be an electric motor. Alternatively, the actuator may be a shift actuator that switches a shift range of the vehicle, and the sensor may be a shift sensor that detects an operation made on a shift lever by the user. As described above, the type of ECU and the types of actuator and/or sensor are not important as long as the ECU and the actuator and/or sensor are used together to allow a user to enter the vehicle and/or to drive the vehicle. The vehicle system 200 according to the present embodiment may be applied to multiple functions, for example, locking and unlocking of the vehicle door, starting the engine, or the like, for a user to board the vehicle and/or to drive the vehicle.

In the vehicle system 200 according to the present embodiment, the condition for activating the ECU (first activation condition) is set to be different from the condition for activating the actuator and/or sensor (second activation condition) for the ECU and the actuator and/or sensor that operate in cooperative manner. For example, the first activation condition may be set, as in the conventional art, a mutual communication is carried out between the mobile device 300, for example, a smart key, a smartphone 300 owned by the user and the vehicle system 200, and a matching success result is obtained by a matching ECU of the vehicle system 200. Tha matching success result indicates that an identifier of the mobile device 300 obtained through the communication matches an identifier of authorized user. When the user can board and drive the vehicle upon satisfaction of only the first activation condition, it is impossible to deal with theft, such as theft using relay attack.

The vehicle system 200 according to the present embodiment is configured so that the actuator and/or the sensor is activated in response to satisfaction of the second activation condition, which is set to be different from the first activation condition. The second activation condition can be set to be satisfied in response to a predetermined operation being carried out by the user using the mobile device 300 carried by the user. For example, when the mobile device 300 is a mobile information terminal, such as a smartphone, the predetermined operation carried out using the mobile device 300 may be an instruction to start an application installed on the mobile information terminal. In this case, the user logs in to the application by entering a pre-registered user ID and password. Then, on the application, a start instruction is executed to enable boarding and use of the vehicle. As a result, the activation instruction is transmitted from the mobile device 300 to the vehicle system 200 via the cloud server 400. The vehicle system 200 can determine whether the second activation condition is satisfied based on the reception of the activation instruction.

When the predetermined operation is performed on the mobile device 300 in the following manner, the second activation condition is satisfied. For example, when the mobile device 300 and the vehicle system 200 have short-range wireless communication functions and the mobile device 300 is located at a position where short-range wireless communication can be performed between the mobile device 300 and the vehicle system 200, the vehicle system 200 can determine that the second activation condition is satisfied. The antenna for short-range wireless communication of the vehicle system 200 can be installed on the door handle or at any position near the dashboard inside the vehicle. Therefore, when the user brings the mobile device 300 close to the door handle or any antenna installation position near the dashboard, short-range wireless communication can be performed between the mobile device 300 and the vehicle system 200. By performing this short-range wireless communication, the vehicle system 200 can determine that the second activation condition is satisfied.

The predetermined operation performed using the mobile device 300 to satisfy the second activation condition may be an unlocking operation using a physical key if the mobile device 300 is equipped with the physical key for unlocking the vehicle door. In this case, when the user performs the unlocking operation using the physical key, the vehicle system 200 can determine that the second activation condition is satisfied.

The predetermined operation performed using the mobile device 300 to satisfy the second activation condition as described above is an operation that is difficult to perform unless the user is an authorized user. Therefore, the vehicle system 200 according to the present embodiment makes it difficult for a third party to steal the vehicle, thereby improving the security performance of the vehicle.

In the above-described example, the first activation condition is satisfied, similar to the conventional art, in response to a matching success result that indicates the identifier of the mobile device 300 matches the identifier of the authorized user, and the second activation condition is satisfied when the predetermined operation is carried out using the mobile device 300. Alternatively, the first activation condition may be configured to be satisfied when the predetermined operation is carried out using the mobile device 300, and the second activation condition may be configured to be satisfied in response to the matching success result that indicates the identifier of the mobile device 300 matches the identifier of the authorized user.

The above-described predetermined operation carried out using the mobile device 300 is an additional operation for the authorized user. Therefore, when such additional operation is always required, the user may feel troublesome when boarding the vehicle and/or driving the vehicle. Therefore, the ECU and the actuator and/or sensor, which operate in cooperative manner, may be configured to be activated under different conditions only when the vehicle system 200 is set to the security mode. This allows authorized user to use the vehicle without performing the additional operation when there is no need to set the vehicle to security mode, for example, when parking the vehicle for a short period of time and then resuming use of the vehicle.

The condition for switching to the security mode may be satisfied when the user performs an operation for switching to the security mode. For example, the operation for switching to the security mode may be performed by touching a multimedia screen installed inside the vehicle or by operating a dedicated physical switch. When the operation for switching to the security mode is performed, the vehicle system 200 switches to the security mode in response to the operation.

Alternatively, the operation for switching to the security mode may be inputting an instruction for switching to the security mode using an application installed in the mobile device 300. In this case, the instruction for switching to the security mode is transmitted from the mobile device 300 to the vehicle system 200 via the cloud server 400. The vehicle system 200 can switch to the security mode in response to receiving the instruction for switching to the security mode.

In another example, the condition for switching to the security mode may be satisfied in response to detection of the vehicle being parked in a specific area. For example, the specific area may be an airport parking lot, a shopping mall parking lot, a shipping yard, a home parking lot, a workplace parking lot, where vehicle is highly likely to be parked for a long period of time. Whether the vehicle is located within the specific area can be determined based on, for example, the vehicle's location as determined by a location determination device such as a GPS equipped on the vehicle. Whether the vehicle is located within the specific area may be determined whether a communication can be carried out with a beacon or Wi-Fi (registered trademark) located within the specific area.

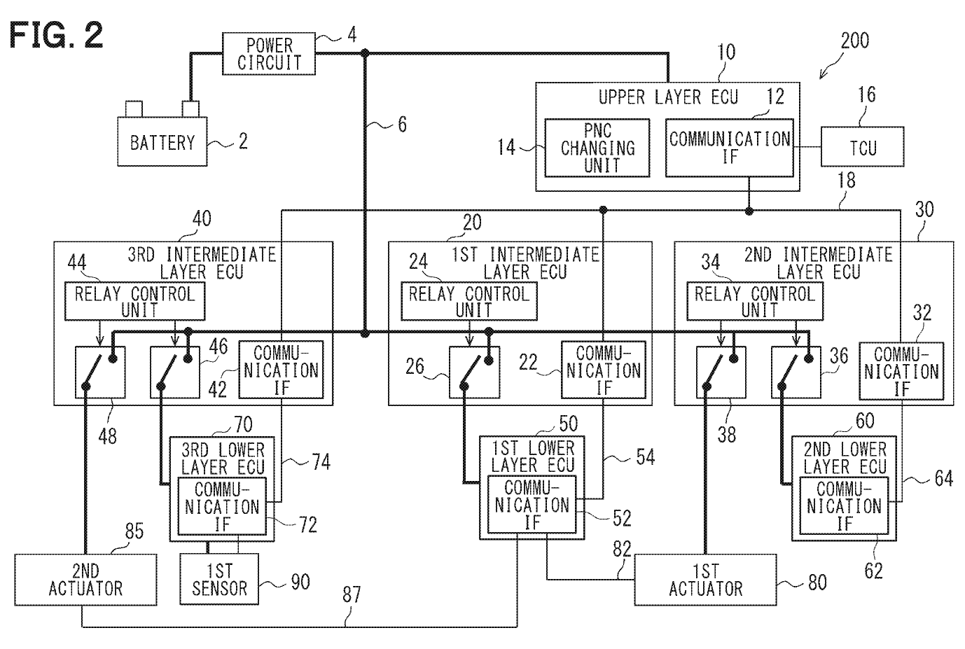

The following will describe a specific configuration example of the vehicle system 200 with reference to FIG. 2. FIG. 2 is a diagram showing an example of the configuration of vehicle system 200 according to the present embodiment. As shown in FIG. 2, the vehicle system 200 includes an upper layer ECU 10, first to third intermediate layer ECUs 20, 30, 40, and first to third lower layer ECUs 50, 60, 70. The upper layer ECU 10, the first to third intermediate layer ECUs 20, 30, 40, and the first to third lower layer ECUs 50, 60, 70 each is provided with a communication interface (IF) 12, 22, 32, 42, 52, 62, 72. The communication IFs 12, 22, 32, 42, 52, 62, 72 are connected to each other via communication buses 18, 54, 64, 74. This configuration enables the upper layer ECU 10, the first to third intermediate layer ECUs 20, 30, 40, and the first to third lower layer ECUs 50, 60, 70 to communicate with one another.

The vehicle system 200 can use CAN (registered trademark) as a communication protocol for the upper layer ECU 10, the first to third intermediate layer ECUs 20, 30, 40, and the first to third lower layer ECUs 50, 60, 70 to communicate with one another. CAN is an abbreviation for Controller Area Network. It should be noted that the communication protocol is not limited to CAN. The vehicle system 200 can adopt various communication protocols such as Ethernet (registered trademark), LIN (Local Interconnect Network), FlexRay (registered trademark), and CAN-FD (CAN with Flexible Data Rate). For example, different communication protocols may be adopted for different communication buses 18, 54, 64, 74.

The vehicle system 200 includes first and second actuators 80, 85 that operate according to instructions from the first lower layer ECU 50. The vehicle system 200 includes a first sensor 90 that provides a sensor signal required for the control process to be executed by the third lower layer ECU 70. In the configuration shown in FIG. 2, the first actuator 80 is connected to the first lower layer ECU 50 via a communication bus 82. The second actuator 85 is connected to the first lower layer ECU 50 via a communication bus 87. The first sensor 90 is connected to the third lower layer ECU 70 via both a power supply line and a communication bus.

The actuator and sensors each may be equipped with a processing unit that has a processing function capable of receiving a message conforming to the above-described communication protocol and performing an operation in accordance with a control instruction included in the message. The processing unit may also have a processing function capable of generating and transmitting a message including information corresponding to the detected sensor signals based on instruction from the upper layer ECU 10. In this case, the above-described communication protocol can also be used for communication between the lower layer ECU and the actuator and sensors. In the present embodiment, the communication between the lower layer ECU and the actuator and sensors does not necessarily have to use the above-described communication protocol. For example, the lower layer ECU may directly transmit, to the actuator, a drive signal for directly driving the actuator. The lower layer ECU may receive a serial signal corresponding to a format of the sensor signal detected by the sensor.

The vehicle system 200 includes the upper layer ECU 10, first to third intermediate layer ECUs 20, 30, 40, first to third lower layer ECUs 50, 60, 70, first and second actuators 80, 85, and first sensor 90, and all of these components may be mounted on the vehicle. As well known, vehicles include passenger cars, motorcycles, transport vehicles, construction vehicles, agricultural vehicles, and the like.

The vehicle system 200 operates with power supply from a battery 2 mounted on the vehicle. More specifically, power from the battery 2 is provided, via a power supply circuit 4, to the upper layer ECU 10, the first to third intermediate layer ECUs 20, 30, 40, the first to third lower layer ECUs 50, 60, 70, the first and second actuators 80, 85, and the first sensor 90 of the vehicle system 200. If necessary, the power supply circuit 4 can convert the power supply voltage of the battery 2 installed in the vehicle into the operating voltages of the upper layer ECU 10, the first to third intermediate layer ECUs 20, 30, 40, the first to third lower layer ECUs 50, 60, 70, the first and second actuators 80, 85, and the first sensor 90.

A power supply line 6 to the first to third lower layer ECUs 50, 60, 70, the first and second actuators 80, 85, and the first sensor 90 includes first to fifth relay circuits 26, 36, 38, 46, 48 whose on/off states are switched by the relay control units 24, 34, 44 of the first to third intermediate layer ECUs 20, 30, 40.

Each of the relay circuits 26, 36, 38, 46, 48 can be implemented by a semiconductor switch, such as a MOSFET (Metal Oxide Semiconductor Field Effect Transistor) or an IGBT (Insulated Gate Bipolar Transistor). Alternatively, each of the relay circuits 26, 36, 38, 46, 48 may be implemented by a normal mechanical relay instead of the semiconductor switch. The relay circuits 26, 36, 38, 46, 48 may be arranged inside the first to third intermediate layer ECUs 20, 30, 40 as shown in FIG. 2, or may be arranged outside the first to third intermediate layer ECUs 20, 30, 40.

The configuration of vehicle system 200 is not limited to the example shown in FIG. 2. For example, the number of upper layer ECUs 10 may be two or more instead of one. In this case, an intermediate layer ECU and a lower layer ECU are arranged below each upper layer ECU. Two or more upper layer ECUs may be communicably connected to one another. One of the intermediate layer ECUs 20, 30, 40 may be configured to perform the functions of upper layer ECU 10, and the upper layer ECU 10 may be omitted. The number of intermediate layer ECUs 20, 30, 40 arranged below the upper layer ECU 10 may be other than three, that is, may be two or less, or four or more. The lower layer ECUs 50, 60, 70 may be connected to one relay circuit, instead of respective relay circuits 26, 36, 46. One of the lower layer ECUs 50, 60, 70 may be configured to receive power supply directly from the power supply circuit 4 without going through the relay circuits 26, 36, 46. Each of the lower layer ECUs 50, 60, 70 may be connected to both an actuator and a sensor. One of the actuator and/or sensor may be configured to receive power supply directly from the power supply circuit 4 without going through the relay circuits 38, 48.

The upper layer ECU 10 can function as a domain controller that controls the first to third lower layer ECUs 50, 60, 70. Domains refers to units of functions when vehicle functions are broadly divided into, for example, a powertrain domain, a chassis domain, an advanced driver assistance domain, a body domain, a cockpit domain, and the like. For example, when the domain controller of the powertrain domain is the upper layer ECU 10, the first to third lower layer ECUs 50, 60, 70 include various ECUs for controlling the vehicle's powertrain, such as an engine ECU, a motor (inverter) ECU, a battery monitoring ECU, and a transmission ECU. When the domain controller of the body domain is the upper layer ECU 10, the first to third lower layer ECUs 50, 60, 70 include various ECUs for controlling the vehicle body, such as an authentication ECU, a door ECU, a window ECU, and a camera ECU.

As the domain controller, the upper layer ECU 10 determines that the lower layer ECU should be activated and operated, and can activate the corresponding lower layer ECU and put the lower layer ECU into an operation state, for example, by transmitting a network management (hereinafter referred to as NM) message. The NM message is explained in more detail below. The upper layer ECU 10 can receive the above-described activation instruction from the mobile device 300 via, for example, a telematics control unit (TCU) 16 that can communicate with the cloud server 400. Upon reception of the activation instruction, the upper layer ECU 10 can determine whether the second activation condition for activating the actuator and/or the sensor is satisfied. Alternatively, the upper layer ECU 10 can also determine whether the second activation condition is satisfied by another predetermined operation, which is performed using the mobile device 300, such as execution of short-range wireless communication. When the upper layer ECU 10 determines that the second activation condition is satisfied, the upper layer ECU 10 can transmit an NM message for activating the actuator and/or sensor. The NM message corresponds to a wake-up message in the present disclosure.

The function of determining that the lower layer ECU should be activated and operated and transmitting the NM message to activate the corresponding lower layer ECU may be performed by the first to third intermediate layer ECUs 20, 30, 40, in addition to or instead of the upper layer ECU 10. When the vehicle is equipped with multiple upper layer ECUs and multiple intermediate layer ECUs corresponding to respective upper layer ECUs, the NM message for activating the lower layer ECU may be transmitted from another upper layer ECU or an intermediate layer ECU corresponding to another upper layer ECU.

The upper layer ECU 10 can receive, via the TCU 16, an instruction for switching to the security mode, or can receive a message from another ECU indicating that an operation for switching to the security mode has been performed. In response to receiving the instruction for switching to the security mode, the upper layer ECU 10 can determine that the condition for switching to the security mode is satisfied. When the upper layer ECU 10 determines that the condition for switching to security mode is satisfied, a PNC changing unit 14, which is to be described later, can change PNC setting information of at least one of the ECU, actuator and/or sensor that operate in cooperative manner so that the ECU, actuator and/or sensor belong to different clusters. The clusters and PNC setting information will be described in more detail below.

The upper layer ECU 10 includes the PNC changing unit 14 as a changing unit of the present disclosure. The PNC changing unit 14 has a function of changing the PNC setting information of the first to third lower layer ECUs 50, 60, 70 and the PNC setting information of the first and second actuators 80, 85. The PNC changing unit 14 has multiple PNC setting tables that include all of the PNC setting information of the first to third lower layer ECUs 50, 60, 70 and the first and second actuators 80, 85. The PNC changing unit 14 changes the PNC setting table when the mode is changed to the security mode. Then, the PNC changing unit 14 changes the PNC setting information of at least one of the first to third lower layer ECUs 50, 60, 70 and the first and second actuators 80, 85 based on the changed PNC setting table.

The PNC changing unit 14 may be included in any one of the first to third intermediate layer ECUs 20, 30, 40, instead of the upper layer ECU 10. When it becomes necessary to change the PNC setting information for at least one of the first to third lower layer ECUs 50, 60, 70 due to the addition or replacement of the first to third lower layer ECUs 50, 60, 70, or addition of an application, the PNC changing unit 14 can obtain an updated PNC setting table, for example, from an external server. Then, the PNC changing unit 14 may change the PNC setting information of the first to third lower layer ECUs 50, 60, 70 to appropriate PNC setting information based on the updated PNC setting table. At this time, the PNC changing unit 14 may reset the PNC setting information of all the lower layer ECUs, or may reset the PNC setting information only for the lower layer ECU whose PNC setting information has been changed.

The following will describe clusters, NM message, PNC setting information, and PNC setting table. In the present embodiment, partial networking is implemented by NM messages, so that the first to third lower layer ECUs 50, 60, 70 are assigned to predetermined clusters, among multiple clusters which are divided in advance. The partial networking means that ECUs belonging to same cluster among multiple clusters are activated (operated), and ECUs belonging to the remaining clusters are powered off or in sleep states. In this way, by activating only the ECUs that need to be operated, it is possible to reduce the power consumption of ECUs mounted on the vehicle.

The PNC setting information, which corresponds to cluster setting information in the present disclosure, indicates the cluster to which each of the lower layer ECUs 50, 60, 70 is assigned. The PNC setting information is stored in the first to third intermediate layer ECUs 20, 30, 40 arranged above the lower layer ECUs 50, 60, 70. Each of the first to third intermediate layer ECUs 20, 30, 40 receives the NM message on behalf of the corresponding lower layer ECU 50, 60, 70. When the received NM message includes activation target cluster information (also referred to as PN request information) that designates the cluster to which the lower layer ECU 50 belongs as an activation target, the first intermediate layer ECU 20 determines that activation of the lower layer ECU 50 is necessary. When the received NM message includes activation target cluster information that designates the cluster to which the lower layer ECU 60 belongs as an activation target, the second intermediate layer ECU 30 determines that activation of the lower layer ECU 60 is necessary. When the received NM message includes activation target cluster information that designates the cluster to which the lower layer ECU 70 belongs as an activation target, the third intermediate layer ECU 40 determines that activation of the lower layer ECU 70 is necessary.

In response to determining that activation of lower layer ECU 50, 60, 70 is necessary, each of the first to third intermediate layer ECUs 20, 30, 40 turns on the relay circuit 26, 36, 46 corresponding to own lower layer ECU 50, 60, 70. As a result, power is supplied to the lower layer ECU 50, 60, 70 whose relay circuit 26, 36, 46 is turned on. As a result, the lower layer ECU 50, 60, 70 with power supplied is activated and switched to an operation state.

When the vehicle system 200 includes a lower layer ECU that is directly supplied with power from the power supply circuit 4 without going through a relay circuit, the lower layer ECU may receive the NM message via the communication IF of the lower layer ECU. In this case, the communication IF of the lower layer ECU determines whether the cluster to which the lower layer ECU belongs matches the cluster defined in the PN request information of the NM message. In response to determining that the cluster to which the lower layer ECU belongs matches the cluster defined in the PN request information of the NM message, the communication IF may switch the lower layer ECU from a sleep state to a wake-up state.

In the present embodiment, clusters are also assigned to actuator and/or sensor. The clusters assigned to the actuator and/or sensor are also stored as PNC setting information in the first to third intermediate layer ECUs 20, 30, 40 arranged above the respective actuator and/or sensor. For example, in the example shown in FIG. 2, the PNC setting information of the first actuator 80 is stored in the second intermediate layer ECU 30, and the PNC setting information of the second actuator 85 is stored in the third intermediate layer ECU 40.

The cluster assigned to the actuator and/or sensor is usually set to the same cluster as the cluster of lower layer ECU that instructs the operation of the actuator or receives a sensor signal from the sensor. As described above, with the switch to security mode, for the lower layer ECU and the actuator and/or sensor operating in cooperative manner for boarding and driving the vehicle, at least one of the PNC setting information of the lower layer ECU and the PNC setting information of the actuator and/or sensor may be changed so that the cluster to which the lower layer ECU belongs is different from the cluster to which the actuator and/or sensor belong.

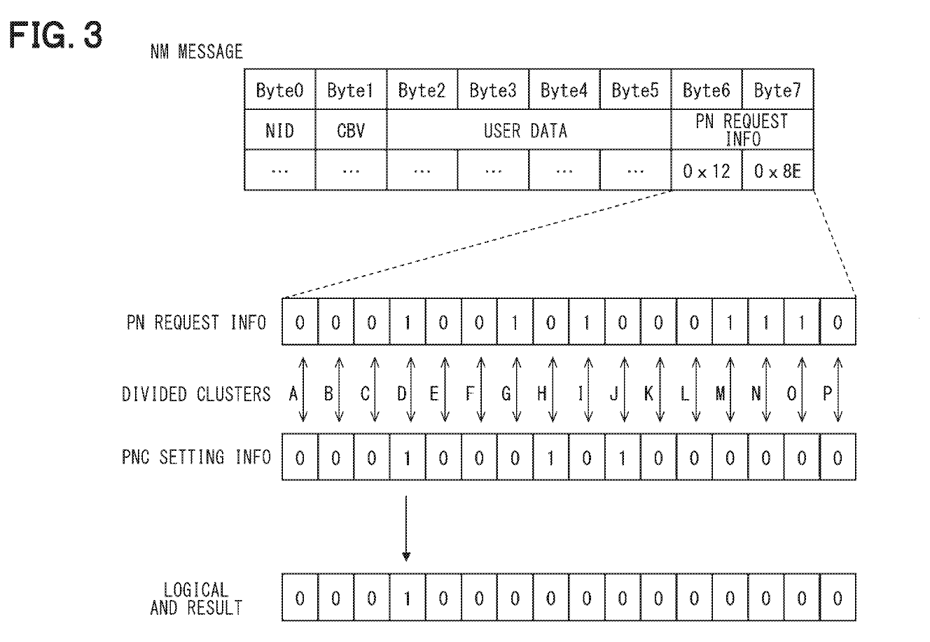

FIG. 3 shows an example of NM message. In the example shown in FIG. 3, the NM message includes data of bytes 0 to 7. Byte 0 contains node ID (NID). The node ID is an identifier preset for each of the upper layer ECU 10, the first to third intermediate layer ECUs 20, 30, 40, and the first to third lower layer ECUs 50, 60, 70. The node ID enables identification of the transmission source of the NM message. Byte 1 contains control bit vector (CBV). The control bit vector contains data indicating whether partial networking is in use or not. When the control bit vector indicates the use of partial networking, the user data area of bytes 2 to 7 contains PN request information, which is activation target cluster information indicating the cluster to be activated.

In the example shown in FIG. 3, the control bit vector indicates the use of partial networking, and the PN request information is stored in bytes 6 and 7 of the user data area. The user data area of bytes 2 to 5 is usable to transmit any information such as an activation factor of ECU or information regarding normality or abnormality, for example. It should be noted that FIG. 3 shows only one example of the format of NM message. The NM message may be in another format as long as the NM message contains PN request information. For example, the NID and CBV may be omitted.

The PN request information indicates, for each of multiple divided clusters, a cluster to be activated and a cluster that does not need to be activated. More specifically, in the example shown in FIG. 3, the clusters are divided into 16 clusters in advance. The PN request information includes 16 bits of data corresponding to the 16 clusters divided in advance. The 16-bit data of the PN request information is previously associated with the 16 clusters divided in advance. When each of the 16 bits of data in the PN request information is "0", it indicates that activation of the associated cluster is not necessary. When each of the 16 bits of data in the PN request information is "1", it indicates that activation of the associated cluster is necessary. The PN request information may indicate only the cluster to be activated. Hereinafter, the cluster to be activated is also referred to as activation target cluster. The PN request information may also indicate only the cluster that do not need to be activated.

FIG. 3 also shows an example of PNC setting information set for the lower layer ECUs, actuator and/or sensor. In the PNC setting information shown in FIG. 3, when the associated clusters are divided as A to P from left to right, the PNC setting information in FIG. 3 indicates that the lower layer ECU, actuator and/or sensor for which the PNC setting information is set belong to clusters D, H, and J. Since the lower layer ECU can perform various functions by executing a program, the lower layer ECU, actuator and/or sensor can belong to one or more clusters.

The first to third intermediate layer ECUs 20, 30, 40 can receive the NM message including the PN request information via the respective communication IFs 22, 32, 42. When receiving the NM message, as shown in FIG. 3, each of the first to third intermediate layer ECUs 20, 30, 40 compares the PN request information defined in the NM message with the PNC setting information of the corresponding lower layer ECU, actuator and/or sensor bit by bit, and calculates a logical AND.

Then, each of the first to third intermediate layer ECUs 20, 30, 40 determines whether the activation target cluster defined by the PN request information of the NM message matches the cluster of PNC setting information set for the corresponding lower layer ECU, actuator and/or sensor. For example, in the example shown in FIG. 3, the activation target clusters requested by the PN request information are clusters D, G, I, M, N, and O. The clusters set in the PNC setting information for the lower layer ECU, actuator and/or sensor are clusters D, H and J. In this case, for cluster D, the cluster requested to be activated by the PN request information of the NM message matches the cluster set in the PNC setting information. Therefore, the result of the logical AND for cluster D is "1" as shown in FIG. 3.

When one bit becomes "1" as a result of the logical AND, each of the first to third intermediate layers ECUs 20, 30, 40 determines that activation of the lower layer ECU, actuator and/or sensor for which the PNC setting information is set as shown in FIG. 3 is requested. In response to this determination result, each of the first to third intermediate layer ECUs 20, 30, 40 turns on the relay circuit corresponding to the lower layer ECU, actuator and/or sensor for which the PNC setting information is set as shown in FIG. 3. When the relay circuit is already turned on, each of the first to third intermediate layer ECUs 20, 30, 40 keeps the turn-on state of relay circuit. When the result of logical AND is that none of the bits is "1" and all are "0", each of the first to third intermediate layer ECUs 20, 30, 40 determines that activation of the lower layer ECUs, actuator and/or sensor for which the PNC setting information is set as in FIG. 3 is not requested. In this case, each of the first to third intermediate layer ECUs 20, 30, 40 turns off the relay circuit corresponding to the lower layer ECU, actuator and/or sensor for which the PNC setting information is set as in FIG. 3.

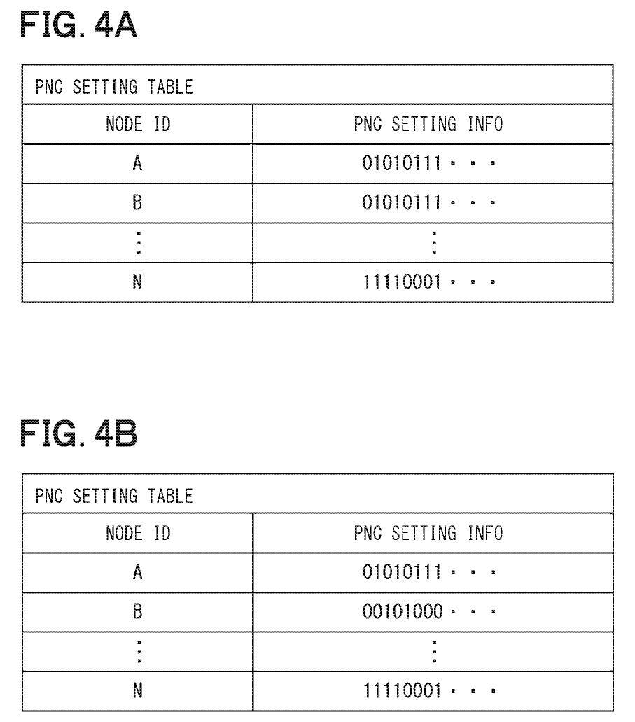

As described above, the PNC changing unit 14 has multiple PNC setting tables that contain all of the PNC setting information for the first to third lower layer ECUs 50, 60, 70 and the first and second actuators 80, 85. For example, the PNC changing unit 14 has a PNC setting table for the normal mode shown in FIG. 4A and a PNC setting table for the security mode shown in FIG. 4B. When the upper layer ECU 10 determines that the condition for switching to the security mode is satisfied, the PNC changing unit 14 changes the PNC setting table for the normal mode to the PNC setting table for the security mode. Then, the PNC changing unit 14 changes the PNC setting information of the first to third lower layer ECUs 50, 60, 70 and the first and second actuators 80, 85 based on the PNC setting table changed for the security mode.

The PNC changing unit 14 transmits the PNC setting information of the first to third lower layer ECUs 50, 60, 70 and the first and second actuators 80, 85 included in the PNC setting table after change, along with an instruction to change the PNC setting information, to the first to third intermediate layer ECUs 20, 30, 40. Each of the first to third intermediate layer ECUs 20, 30, 40 change the PNC setting information of the corresponding lower layer ECU 50, 60, 70 and the first and second actuators 80, 85 based on the received PNC setting information. At this time, the PNC changing unit 14 may transmit a change instruction to the intermediate layer ECU, which has the corresponding PNC setting information set different between the PNC setting table for the normal mode and the PNC setting table for the security mode.

In the PNC setting table for the security mode, the PNC setting information is defined so that the cluster of lower layer ECU is set to be different from the cluster of actuator and/or sensor in a case where the lower layer ECU operate in cooperative manner with the actuator and/or sensor. Thus, the lower layer ECU and the actuator and/or sensor that operate together will be activated separately in response to different NM messages. In the present embodiment, the upper layer ECU 10 is configured to transmit the NM message to activate the ECU when the first activation condition is satisfied, and to transmit the NM message to activate the actuator and/or sensor when the second activation condition set to be different from the first activation condition is satisfied. Thus, the ECU and the actuator and/or sensor that operate in cooperative manner are activated when different activation conditions are respectively satisfied.

It is also possible to set the PNC setting information for the upper layer ECU 10 and/or the first to third intermediate layer ECUs 20, 30, 40 so that the activated state (operation state) and the sleep state can be switched by an NM message. Alternatively, the upper layer ECU 10 and/or the first to third intermediate layer ECUs 20, 30, 40 may be configured to maintain the operation state while the NM messages are received from another ECU, and may be configured to enter the sleep state in response to elapse of a predetermined period of time from the last reception of NM message from another ECU.

As described above, the first to third intermediate layer ECUs 20, 30, 40 respectively have first to third relay control units 24, 34, 44 that control the on/off of the corresponding relay circuits 26, 36, 38, 46, 48. The first to third relay control units 24, 34, 44 each has a table showing the correspondence between the lower layer ECU, actuator and/or sensor and the relay circuits 26, 36, 38, 46, 48. When each of the first to third intermediate layer ECUs 20, 30, 40 determines based on the NM message that activation of the lower layer ECU, actuator and/or sensor is requested, the corresponding one of first to third relay control units 24, 34, 44 refers to a table to identify the corresponding relay circuit. Then, each of the first to third relay control units 24, 34, 44 turns on the identified relay circuit.

The first to third intermediate layer ECUs 20, 30, 40 have the functions of turning on and off the respective relay circuits 26, 36, 38, 46, 48, and also serve as relay devices for enabling two-way communication between ECUs connected to different communication buses 18, 54, 64, 74. For example, each of the first to third intermediate layer ECUs 20, 30, 40 relays the NM messages received from one communication bus 18, 54, 64, 74 to another communication bus 18, 54, 64, 74. In addition to the NM messages for implementing the partial networking, control messages including control related data are also exchanged between the first to third lower layer ECUs 50, 60, 70. The first to third intermediate layer ECUs 20, 30, 40 also function as gateways for transferring such control messages. This configuration enables smooth cooperative control by multiple lower layer ECUs belonging to the same cluster.

In the operation state, each of the first to third lower layer ECUs 50, 60, 70 transmits an NM message including PN request information that designates the cluster to which own ECU belongs as the activation target cluster while execution of a predetermined control process, calculation process, drive process, or the like. When the execution of the predetermined control process, calculation process, drive process, or the like is completed, each of the first to third lower layer ECUs 50, 60, 70 stops transmission of the NM message. Then, when a predetermined period of time has elapsed since the first to third intermediate layer ECUs 20, 30, 40 receives the last NM message containing PN request information that designates the cluster to which corresponding lower layer ECU, actuator and/or sensor belongs as the activation target cluster, the intermediate layer ECU turns off the relay circuit corresponding to the lower layer ECU, actuator, and/or sensor. As a result, the lower layer ECU, actuator and/or sensor belonging to the same cluster switch from the operation state to a power-off state at approximately the same time. In this way, it becomes possible to activate only the necessary ECU, actuator and/or sensor in units of cluster, thereby enabling the partial networking.

The following will describe a specific example in which the vehicle system 200 shown in FIG. 2 is applied to switching a vehicle door between a locking state and an unlocking state. In this case, the first lower layer ECU 50 is configured as a door ECU to transmit an instruction signal (messages) to the first and second actuators 80, 85, which correspond to door lock motors, and instruct the first and second actuators 80, 85 to operate. The first lower layer ECU 50 corresponds to a management target control device of the present disclosure, and the actuator and/or sensor corresponds to a management target device. The management target device includes at least one of an actuator or a sensor. The first intermediate layer ECU 20 corresponds to a first upper layer control device, and the second and third intermediate layer ECUs 30, 40 correspond to second upper layer control devices.

Although not shown in FIG. 2, the first lower layer ECU 50 may be configured to receive a sensor signal from a touch sensor to control the first and second actuators 80 and 85. In this case, when the second activation condition is satisfied, the touch sensor is configured to receive power via a relay circuit by one of the intermediate layer ECUs.

The second lower layer ECU 60 may be an authentication ECU that has the function of communicating with the mobile device 300 and authenticating whether the identifier of mobile device 300 obtained through the communication matches a preset identifier indicating the authorized user. For example, the upper layer ECU 10 transmits an NM message including PN request information with the cluster to which the second lower layer ECU 60 belongs as the activation target cluster at a predetermined interval. In response to the NM message, the second intermediate layer ECU 30 turns on the relay circuit 36 corresponding to the second lower layer ECU 60. As a result, power is supplied to the second lower layer ECU 60, and the second lower layer ECU 60 is activated and switched to the operation state. The second lower layer ECU 60 that has switched to the operation state attempts to communicate with the mobile device 300 by transmitting a wireless signal to the mobile device 300. When the second lower layer ECU 60 receives the response signal from the mobile device 300, the second lower layer ECU 60 checks whether the identifier of the mobile device 300 matches or is identical to the preset identifier indicating the authorized user. When no response signal is received from the mobile device 300 for a predetermined period of time, the second lower layer ECU 60 stops operation.

When the second lower layer ECU 60 determines that the identifier of the mobile device 300 matches the identifier indicating the authorized user, the upper layer ECU 10 (or the second lower layer ECU 60) generates and transmits an NM message including PN request information that specifies the cluster to which the first lower layer ECU 50 belongs as the activation target cluster. In response to the NM message, the first intermediate layer ECU 20 turns on the relay circuit 26 corresponding to the first lower layer ECU 50. As a result, power is supplied to the first lower layer ECU 50, and the first lower layer ECU 50 is activated and switched to the operation state.

When the upper layer ECU 10 determines that the user has performed the predetermined operation using the mobile device 300, the is, the second activation condition is satisfied, the upper layer ECU 10 generates and transmits an NM message including the PN request information that designates the cluster to which the first and second actuators 80, 85 belong as the activation target cluster. The PNC setting information is set so that the first and second actuators 80 and 85 belong to the same cluster. In response to the NM message, the second and third intermediate layer ECUs 30, 40 turn on the respective relay circuits 38, 48 corresponding to the first and second actuators 80, 85. As a result, power is supplied to the first and second actuators 80, 85, and the first and second actuators 80, 85 are switched to the operation states.

The first and second actuators 80 and 85 will not be put into the operation states unless the user performs the predetermined operation using the mobile device 300. Therefore, even when a malicious third party attempts to steal the vehicle by relay attack, the first and second actuators 80, 85 will not be activated, and the doors will not be unlocked. Therefore, vehicle theft can be effectively prevented.

The first sensor 90 may be a camera that captures images of a periphery area of the vehicle. The third lower layer ECU 70 may be a monitoring ECU that monitors the periphery area of the vehicle based on the images captured by the camera.

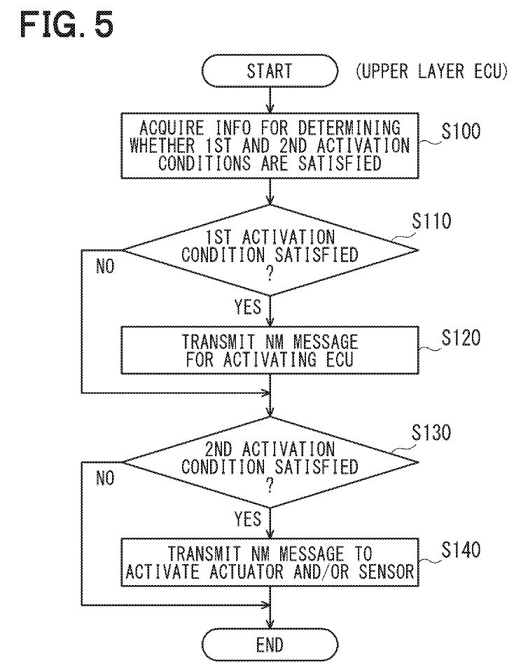

The following will describe an example of specific process executed by the upper layer ECU 10 and the first to third intermediate layer ECUs 20, 30, 40, with reference to the flowcharts of FIG. 5 to FIG. 8. The execution of process shown in the flowcharts of FIG. 5 to FIG. 8 by the upper layer ECU 10 and the first to third intermediate layer ECUs 20, 30, 40 corresponds to the execution of a control method for controlling the vehicle system 200 in the present disclosure.

The flowchart of FIG. 5 will be described. FIG. 5 is a flowchart showing an example of process executed by the upper layer ECU 10. The upper layer ECU 10 periodically executes the process shown in the flowchart of FIG. 5. When at least one of the first to third intermediate layer ECUs 20, 30, 40 also serves as the upper layer ECU 10, the process shown in the flowchart of FIG. 5 is executed by at least one of the first to third intermediate layer ECUs 20, 30, 40 that also serves as the upper layer ECU 10.

In S100, the upper layer ECU 10 acquires information for determining whether the first activation condition and the second activation condition are satisfied. For example, the upper layer ECU 10 acquires an authentication result from the above-described authentication ECU as information for determining whether the first activation condition is satisfied. The upper layer ECU 10 may receive an activation instruction from the mobile device 300 via the TCU 16 as information for determining whether the second activation condition is satisfied. The upper layer ECU may receive information from a short-range wireless device, which performs short-range wireless communication with the mobile device 300, information indicating that short-range wireless communication is performed with the mobile device 300 as information for determining whether the second activation condition is satisfied.

In S110, the upper layer ECU 10 determines whether the first activation condition is satisfied based on the information acquired in S100. In response to determining that the first activation condition is satisfied, the upper layer ECU 10 proceeds to S120. In response to determining that the first activation condition is not satisfied, the upper layer ECU 10 proceeds to S130.

In S120, the upper layer ECU 10 generates and transmits the NM message including PN request information specifying the cluster, to which the lower layer ECU (for example, the door ECU described above) to be activated in response to satisfaction of the first activation condition belongs, as the activation target cluster.

In S130, the upper layer ECU 10 determines whether the second activation condition is satisfied based on the information acquired in S100. In response to determining that the second activation condition is satisfied, the upper layer ECU 10 proceeds to S140. In response to determining that the second activation condition is not satisfied, the upper layer ECU 10 ends the process shown in the flowchart of FIG. 5.

In S140, the upper layer ECU 10 generates and transmits the NM message including PN request information specifying the cluster, to which the actuator and/or sensor (for example, the door lock motor and/or touch sensor described above) to be activated in response to satisfaction of the second activation condition belongs, as the activation target cluster.

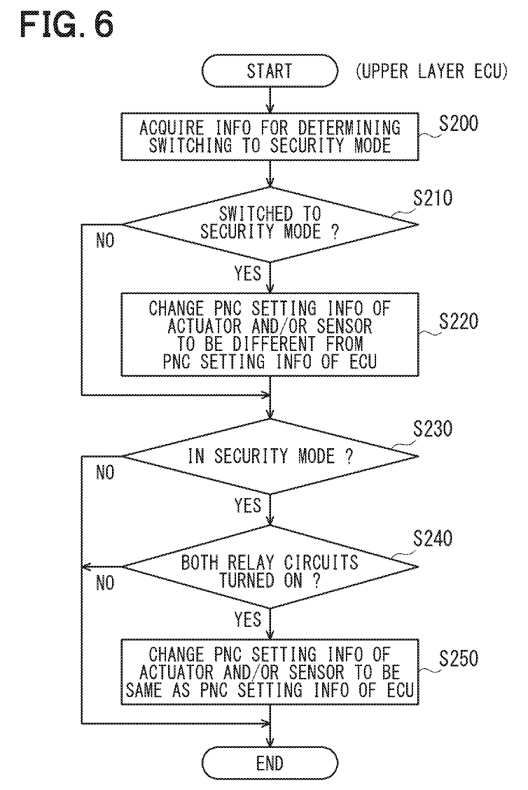

The flowchart of FIG. 6 will be described. FIG. 6 is a flowchart showing a process executed by the upper layer ECU 10 for switching between the normal mode and the security mode. The upper layer ECU 10 periodically executes the process shown in the flowchart of FIG. 6. When the PNC changing unit 14 is arranged in an ECU other than the upper layer ECU 10, the process shown in the flowchart of FIG. 6 is executed by the ECU that includes the PNC changing unit 14.

In S200, the upper layer ECU 10 acquires information for determining whether to switch to the security mode. For example, the upper layer ECU 10 may acquire information indicating that a user has performed an operation to switch to the security mode from the TCU 16 or from another control device as information for determining switching to the security mode. The upper layer ECU 10 may acquire information indicating that the vehicle is parked in the specific area from a position specifying device or the like as information for determining whether to switch to the security mode.

In S210, the upper layer ECU 10 determines whether to switch to the security mode based on the information acquired in S200. In response to determining the mode switch to the security mode, the upper layer ECU 10 proceeds to S220. In response to failing to determine mode switch to the security mode, the upper layer ECU 10 proceeds to S230.

In S220, the upper layer ECU 10 changes the PNC setting information of the actuator and/or sensor using the PNC setting table for the security mode. As a result, the PNC setting information of the actuator and/or sensor is changed so that the cluster to which the actuator and/or sensor belong is set to be different from the cluster to which the lower layer ECU belongs. Herein, the actuator and/or sensor operate in cooperative manner with the lower layer ECU for door locking or unlocking purpose. At this time, the upper layer ECU 10 may change the PNC setting information of the lower layer ECU. Alternatively, the upper layer ECU 10 may change the PNC setting information of both the lower layer ECU and the actuator and/or sensor.

In S230, the upper layer ECU 10 determines whether the security mode is in effect. In response to determining that the security mode is in effect, the upper layer ECU 10 proceeds to S240. In response to determining that the security mode is not in effect, the upper layer ECU 10 ends the process shown in the flowchart of FIG. 6.

In S240, the upper layer ECU 10 determines whether both the relay circuit corresponding to the lower layer ECU and the relay circuit corresponding to the actuator and/or sensor are turned on. Specifically, the upper layer ECU 10 determines whether both the first activation condition for activating the lower layer ECU and the second activation condition for activating the actuator and/or the sensor are satisfied. In response to determining that both relay circuits are turned on, the upper layer ECU 10 proceeds to S250. In response to failing to determine that both relay circuits are turned on, the upper layer ECU 10 ends the process shown in the flowchart of FIG. 6.

In S250, the upper layer ECU 10 changes the PNC setting information of the actuator and/or sensor using the PNC setting table for the normal mode. As a result, the PNC setting information of the actuator and/or sensor is changed again so that the cluster to which the actuator and/or sensor belong is the same as the cluster to which the lower layer ECU belongs.

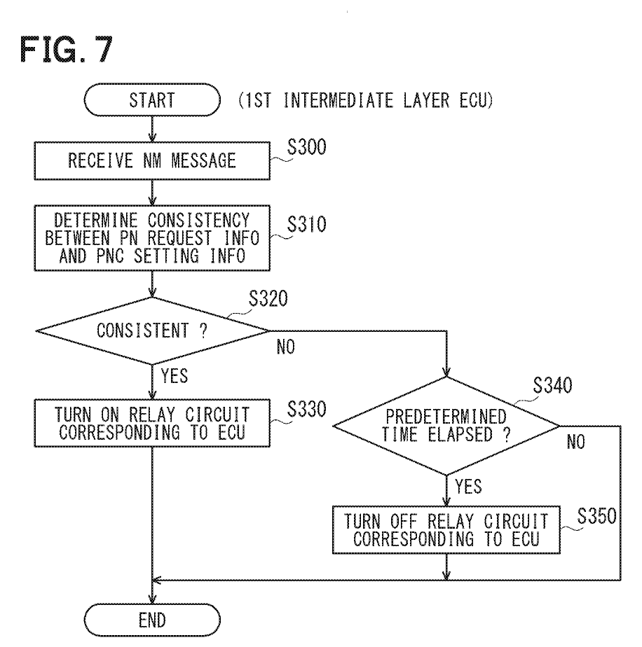

The flowchart of FIG. 7 will be described. FIG. 7 is a flowchart showing an example of process executed by an intermediate layer ECU (for example, the first intermediate layer ECU 20). the intermediate layer ECU is located in an upper layer of the lower layer ECU and is activated in response to the satisfaction of the first activation condition. In the following description, suppose that the first intermediate layer ECU 20 executes the process shown in the flowchart of FIG. 7. The first intermediate layer ECU 20 periodically executes the process shown in the flowchart of FIG. 7.

In S300, the first intermediate layer ECU 20 receives the NM message via the communication IF 22. In S310, the first intermediate layer ECU 20 determines whether the activation target cluster defined by the PN request information of the received NM message matches or consistent to the cluster defined by the PNC setting information set for the first lower layer ECU 50.

In S320, the first intermediate layer ECU 20 determines, based on the determination result of S310, whether the activation target cluster defined by the PN request information of the NM message is consistent to the cluster defined by the PNC setting information set for the first lower layer ECU 50. In response to determining matching success, the first intermediate layer ECU 20 proceeds to S330. In response to determining matching failure, the first intermediate layer ECU 20 proceeds to S340.

In S330, the first intermediate layer ECU 20 turns on the relay circuit 26 corresponding to the first lower layer ECU 50. As a result, power is supplied to the first lower layer ECU 50, and the first lower layer ECU 50 enters the operation state. In S340, the first intermediate layer ECU 20 determines whether a predetermined period of time has elapsed since last reception of the NM message, which includes the PN request information designating the activation target cluster as the cluster to which the lower layer ECU 50 belongs. In response to determining that the predetermined period of time has elapsed, the first intermediate layer ECU 20 proceeds to S350. In response to determining that the predetermined period of time has not elapsed, the first intermediate layer ECU 20 ends the process shown in the flowchart of FIG. 7.

As described above, in the operation state, while the first lower layer ECU 50 is executing the predetermined control process or the like, the first lower layer ECU 50 also transmits the NM message, which includes the PN request information designating the cluster to which own ECU belongs as the activation target cluster. Therefore, when the above-described predetermined period of time has elapsed, the first lower layer ECU 50 can determine that the control process has ended. Therefore, the first intermediate layer ECU 20 turns off the relay circuit 26 corresponding to the first lower layer ECU 50 in S350. As a result, the supply of power to the first lower layer ECU 50 is cut off.

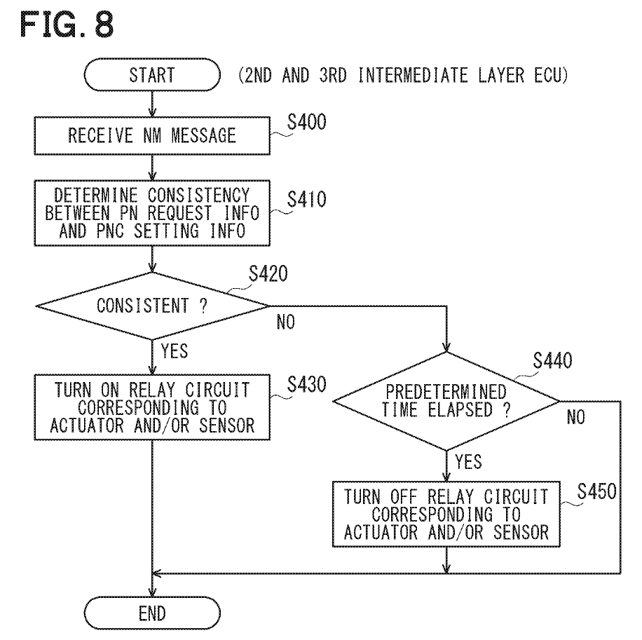

The flowchart of FIG. 8 will be described. FIG. 8 is a flowchart showing a process executed by the intermediate layer ECU (for example, the second and third intermediate layer ECUs 30, 40) located in an upper layer than an actuator and/or sensor that is activated in response to the second activation condition being satisfied. In the following description, suppose that the second intermediate layer ECU 30 executes the process shown in the flowchart of FIG. 8. The second intermediate layer ECU 30 periodically executes the process shown in the flowchart of FIG. 8.

In S400, the second intermediate layer ECU 30 receives the NM message via the communication IF 32. In S410, the second intermediate layer ECU 30 determines whether the activation target cluster defined by the PN request information of the received NM message matches or consistent to the cluster defined by the PNC setting information set for the subordinate actuator and/or sensor (for example, the first actuator 80).

In S420, the second intermediate layer ECU 30 determines, based on the determination result of S410, whether the activation target cluster defined by the PN request information of the NM message is consistent to the cluster defined by the PNC setting information set for the actuator and/or sensor. In response to determining matching success, the second intermediate layer ECU 30 proceeds to S430. In response to determining matching failure, the second intermediate layer ECU 30 proceeds to S440.

In S430, the second intermediate layer ECU 30 turns on the relay circuit 38 corresponding to the actuator and/or sensor. As a result, power is supplied to the actuator and/or sensor, and the actuator and/or sensor are switched to the operation states. In S440, the second intermediate layer ECU 30 determines whether a predetermined period of time has elapsed since last reception of the NM message, which includes the PN request information designating the activation target cluster as the cluster to which the actuator and/or sensor belongs. In response to determining that the predetermined period of time has elapsed, the second intermediate layer ECU 30 proceeds to S450. In response to determining that the predetermined time has not elapsed, the second intermediate layer ECU 30 ends the process shown in the flowchart of FIG. 8.

As described above, when both of the relay circuit corresponding to the lower layer ECU and the relay circuit corresponding to the actuator and/or sensor are turned on, the PNC setting information of the actuator and/or sensor is changed to be the same as the PNC setting information of the lower layer ECU. Therefore, when the relay circuit of the actuator and/or sensor is turned on and a predetermined period of time has elapsed from last reception of NM message, which includes the PN request information designating the cluster to which own lower layer ECU belongs as the activation target cluster, the second intermediate layer ECU 30 can determine that the lower layer ECU has completed its control process. Therefore, in S450, the second intermediate layer ECU 30 turns off the relay circuit 38 corresponding to the actuator and/or sensor. As a result, power supply to the actuator and/or sensor is cut off. While the actuator and/or sensor are operating in accordance with the message from the lower layer ECU, the actuator and/or sensor may also periodically transmit the NM messages, which includes the PN request information designating the cluster to which own device belong as the activation target cluster.

### Second Embodiment

The following will describe a vehicle system 200 according to a second embodiment of the present disclosure. The vehicle system 200 according to the present embodiment has similar configuration to the vehicle system 200 according to the first embodiment, and therefore description of the configuration will be omitted.

In the vehicle system 200 according to the first embodiment, when the upper layer ECU 10 determines that the first activation condition is satisfied, the upper layer ECU transmits the NM message to activate the lower layer ECU. When the upper layer ECU 10 determines that the second activation condition, which is set to be different from the first activation condition, is satisfied, the upper layer ECU transmits the NM message to activate the actuator and/or sensor.

In the vehicle system 200 according to the present embodiment, when the upper layer ECU 10 determines that the second activation condition is satisfied, the upper layer ECU 10 changes the PNC setting information set for the actuator and/or sensor to be the same as the PNC setting information set for the lower layer ECU. As a result, the actuator and/or sensor are activated by the NM message transmitted from the upper layer ECU 10 in response to the first activation condition is satisfied, just like the lower layer ECU.

In the present embodiment, unless the second activation condition is satisfied, the PNC setting information of the actuator and/or sensor is not changed to be the same as the PNC setting information of the lower layer ECU. Therefore, the actuator and/or sensor are not activated simply by the NM message to activate the lower layer ECU. As a result, in the vehicle system 200 according to the present embodiment, the lower layer ECU is activated in response to the first activation condition being satisfied, and the actuator and/or sensor is activated in response to the second activation condition being satisfied. Herein, the second activation condition is set to be different from the first activation condition.

Alternatively, when the upper layer ECU 10 determines that the first activation condition is satisfied, the upper layer ECU 10 may change the PNC setting information set for the lower layer ECU to be the same as the PNC setting information set for the actuator and/or sensor. In this case, the lower layer ECU, together with the actuator and/or the sensor, is activated by the NM message transmitted from the upper layer ECU 10 in response to the second activation condition being satisfied.

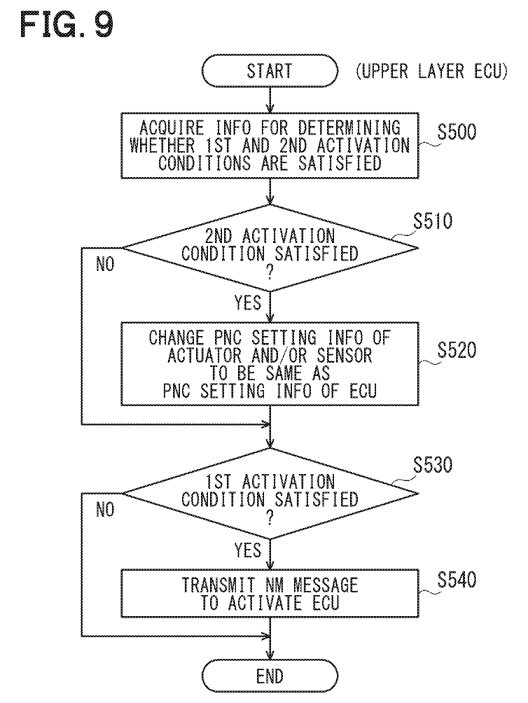

An example of process executed by the upper layer ECU 10 in the vehicle system 200 according to the present embodiment will be described with reference to the flowchart of FIG. 9. In the flowchart of FIG. 9, when the upper layer ECU 10 determines that the second activation condition is satisfied, the upper layer ECU 10 changes the PNC setting information set for the actuator and/or sensor to be the same as the PNC setting information set for the lower layer ECU. After the security mode is set, the upper layer ECU 10 may periodically execute the process shown in the flowchart of FIG. 9.

In S500, the upper layer ECU 10 acquires information for determining whether the first activation condition and the second activation condition are satisfied. In S510, the upper layer ECU 10 determines whether the second activation condition is satisfied based on the information acquired in S500. In response to determining that the second activation condition is satisfied, the upper layer ECU 10 proceeds to S520. In response to determining that the second activation condition is not satisfied, the upper layer ECU 10 proceeds to S530.

In S520, the upper layer ECU 10 changes the PNC setting information of the actuator and/or sensor so that the PNC setting information of the actuator and/or sensor is the same as the PNC setting information of the lower layer ECU. Then, the upper layer ECU 10 proceeds to S530.

In S530, the upper layer ECU 10 determines whether the first activation condition is satisfied based on the information acquired in S500. In response to determining that the first activation condition is satisfied, the upper layer ECU 10 proceeds to S540. In response to determining that the first activation condition is not satisfied, the upper layer ECU 10 ends the process shown in the flowchart of FIG. 9.

In S540, the upper layer ECU 10 generates and transmits the NM message for activating the lower layer ECU that should be activated when the first activation condition is satisfied. In the second and third intermediate layer ECUs 30, 40, suppose that the PNC setting information of the actuator and/or sensor is changed to the same as the PNC setting information of the lower layer ECU. In this case, when the second and third intermediate layer ECUs 30, 40 receive the NM message to activate the lower layer ECU, the relay circuits 38, 48 corresponding to the actuator and/or sensor may be configured to turn on in response to the reception of NM message. As a result, the actuator and/or sensor as well as the lower layer ECUs are powered on and switch to the operation states.

The switching process between the normal mode and the security mode executed by the upper layer ECU 10 and the process executed by the first to third intermediate layer ECUs 20, 30, 40 are the same as those in the first embodiment, and therefore will not be described again.

### Third Embodiment

The following will describe a vehicle system 200 according to a third embodiment of the present disclosure. The vehicle system 200 according to the present embodiment has similar configuration to the vehicle system 200 according to the first embodiment, and therefore description of the configuration will be omitted.

In the vehicle system 200 according to the first embodiment, the upper layer ECU 10 transmits the NM message to the first to third intermediate layer ECUs 20, 30, 40 to activate the respective lower layer ECUs, actuator and/or sensor.

In the vehicle system 200 according to the present embodiment, instead of the NM message, the upper layer ECU 10 transmits a relay control message to the first to third intermediate layer ECUs 20, 30, 40 to directly instruct the relay circuits 26, 36, 38, 46, 48 to be turned on or off. When the first to third intermediate layer ECUs 20, 30, 40 receive the relay control message from the upper layer ECU 10, they turn on or off the corresponding relay circuits 26, 36, 38, 46, 48 in accordance with the instruction in the relay control message.

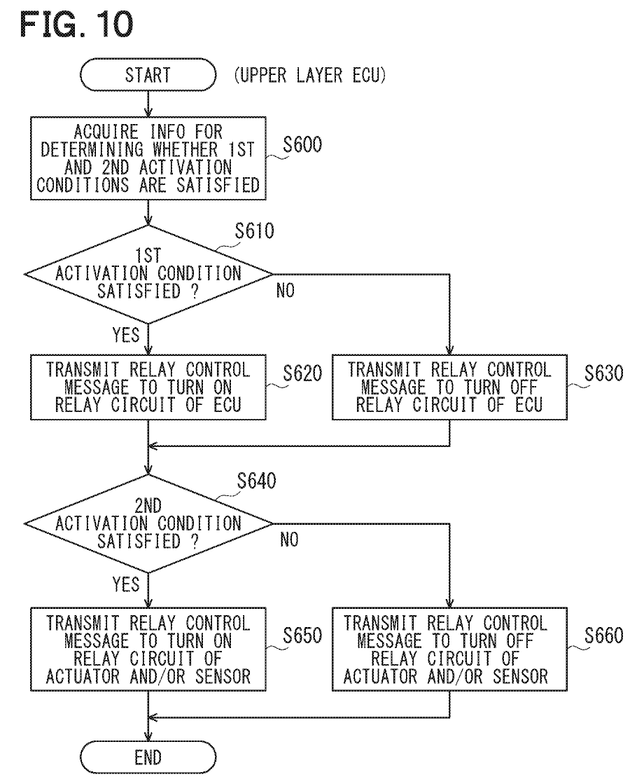

An example of process executed by the upper layer ECU 10 in the vehicle system 200 according to the present embodiment will be described with reference to the flowchart of FIG. 10. After the security mode is set, the upper layer ECU 10 may periodically execute the process shown in the flowchart of FIG. 10.

In S600, the upper layer ECU 10 acquires information for determining whether the first activation condition and the second activation condition are satisfied. In S610, the upper layer ECU 10 determines whether the first activation condition is satisfied based on the information acquired in S600. In response to determining that the first activation condition is satisfied, the upper layer ECU 10 proceeds to S620. In response to determining that the first activation condition is not satisfied, the upper layer ECU 10 proceeds to S630.

In S620, the upper layer ECU 10 generates the relay control message that instructs turn-on of the relay circuit corresponding to the lower layer ECU that should be activated when the first activation condition is satisfied, and transmits the generated relay control message to the intermediate layer ECU that controls the corresponding relay circuit. In S630, the upper layer ECU 10 generates the relay control message that instructs turn-off of the relay circuit corresponding to the lower layer ECU that should be deactivated in response to the first activation condition being not satisfied, and transmits the generated relay control message to the intermediate layer ECU that controls the corresponding relay circuit. The upper layer ECU 10 may further transmit a relay control message that instructs turn-off of the relay circuit corresponding to the lower layer ECU that should be deactivated after confirming that the control process of the lower layer ECU is completed.

In S640, the upper layer ECU 10 determines whether the second activation condition is satisfied based on the information acquired in S600. In response to determining that the second activation condition is satisfied, the upper layer ECU 10 proceeds to S650. In response to determining that the second activation condition is not satisfied, the upper layer ECU 10 proceeds to S660.

In S650, the upper layer ECU 10 generates the relay control message that instructs turn-on of the relay circuit corresponding to the actuator and/or sensor that should be activated when the second activation condition is satisfied, and transmits the generated relay control message to the intermediate layer ECU that controls the corresponding relay circuit. In S660, the upper layer ECU 10 generates the relay control message that instructs turn-off of the relay circuit corresponding to the actuator and/or sensor that should be deactivated in response to the second activation condition being not satisfied, and transmits the generated relay control message to the intermediate layer ECU that controls the corresponding relay circuit. The upper layer ECU 10 may further transmit a relay control message instructing the relay circuit corresponding to the actuator and/or sensor to be turned off after confirming that the control process of the lower layer ECU has been completed or after confirming that the actuator and/or sensor has stopped operation.

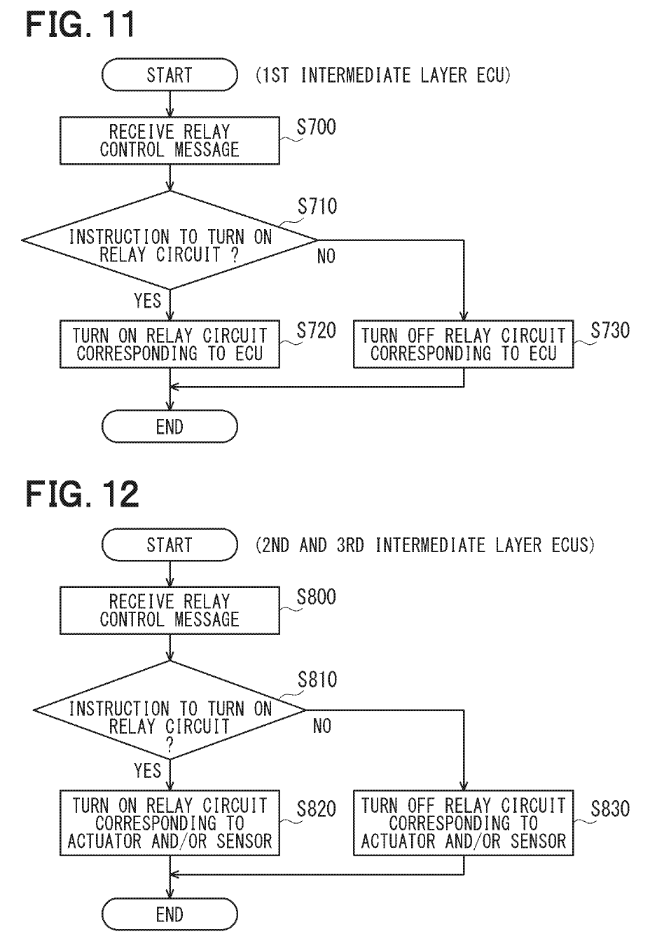

An example of the process executed by the first to third intermediate layer ECUs 20, 30, 40 in the vehicle system 200 according to the present embodiment will be described with reference to the flowcharts of FIG. 11 and FIG. 12. The flowcharts of FIG. 11 and FIG. 12 show examples in which the first intermediate layer ECU 20 controls the relay circuit 26 as the relay circuit corresponding to the lower layer ECU, and the second and third intermediate layer ECUs 30, 40 control the respective relay circuits 38, 48 as relay circuits corresponding to the actuator and/or sensor.

FIG. 11 is a flowchart showing an example of process executed by the first intermediate layer ECU 20. The first intermediate layer ECU 20 periodically executes the process shown in the flowchart of FIG. 11.

In S700, the first intermediate layer ECU 20 receives a relay control message from the upper layer ECU 10. In S710, the first intermediate layer ECU 20 determines whether the relay control message is an instruction to turn on the relay circuit 26, which is managed by own ECU. In response to determining that the relay control message is the instruction to turn on the relay circuit 26, the first intermediate layer ECU 20 proceeds to S720. In response to determining that the relay control message is not the instruction to turn on the relay circuit 26, that is, the relay control message is the instruction to turn off the relay circuit 26, the first intermediate layer ECU 20 proceeds to S730.

In S720, the first intermediate layer ECU 20 turns on the relay circuit 26. As a result, power is supplied to the first lower layer ECU 50, and the first lower layer ECU 50 enters the operation state. In S730, the first intermediate layer ECU 20 turns off the relay circuit 26. As a result, the supply of power to the first lower layer ECU 50 is cut off.

The following will describe an example of process executed by the second and third intermediate layer ECUs 30, 40 with reference to the flowchart of FIG. 12. The following description under a condition that the second intermediate layer ECU 30 executes the process shown in the flowchart of FIG. 12. The second intermediate layer ECU 30 periodically executes the process shown in the flowchart of FIG. 12.

In S800, the second intermediate layer ECU 30 receives the relay control message from the upper layer ECU 10. In S810, the second intermediate layer ECU 30 determines whether the relay control message is an instruction to turn on the relay circuit 38, which is managed by own ECU 30, to supply power to the corresponding actuator and/or sensor. In response to determining that the relay control message is the instruction to turn on the relay circuit 38, the second intermediate layer ECU 30 proceeds to S820. In response to determining that the relay control message is not the instruction to turn on the relay circuit 38, that is, the relay control message is the instruction to turn off the relay circuit 38, the second intermediate layer ECU 30 proceeds to S830.

In S820, the second intermediate layer ECU 30 turns on the relay circuit 38. As a result, power is supplied to the actuator and/or sensor, and the actuator and/or sensor are switched to the operation states. In S830, the second intermediate layer ECU 30 turns off the relay circuit 38. As a result, power supply to the actuator and/or sensor is cut off.

### Fourth Embodiment

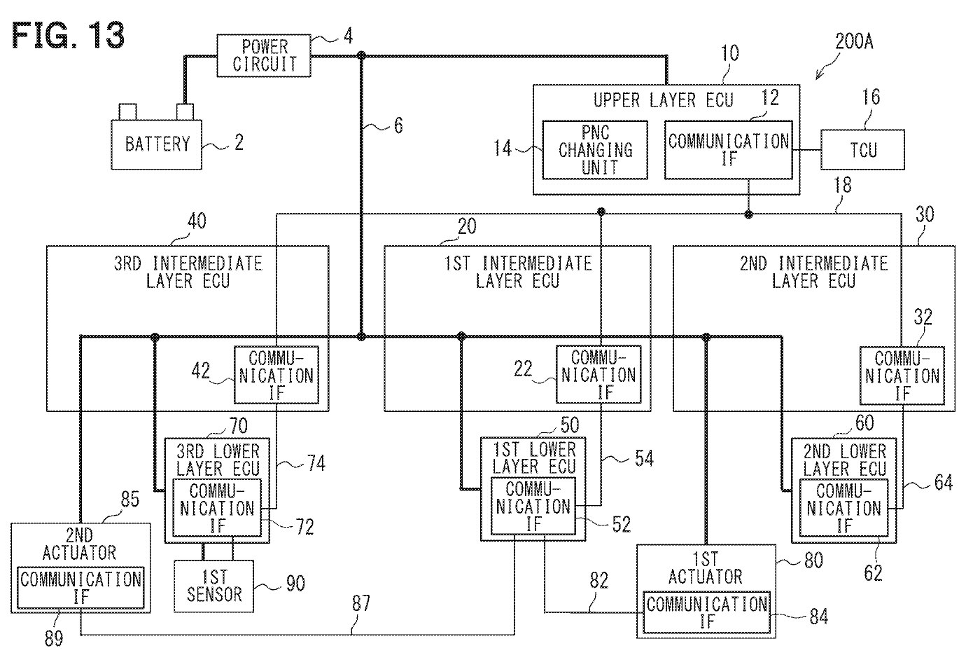

The following will describe a vehicle system according to a fourth embodiment of the present disclosure. FIG. 13 is a diagram showing an example of a configuration of a vehicle system 200A according to the present embodiment.

In the vehicle system 200A according to the present embodiment, unlike the vehicle systems 200 according to the first to third embodiments, the first to third lower layer ECUs 50, 60, 70 and the first and second actuators 80, 85 are supplied with power directly from the power supply circuit 4, as shown in FIG. 13.

In the vehicle system 200A according to the present embodiment, the communication IFs 52, 62, 72, 84, 89 of the first to third lower layer ECUs 50, 60, 70 and the first and second actuators 80, 85 are configured to be able to receive NM messages in the sleep state. That is, the first to third lower layer ECUs 50, 60, 70 and the first and second actuators 80, 85 are provided with communication IFs 52, 62, 72, 84, 89 that support the partial networking function.

Each communication IF 52, 62, 72, 84, 89 determines whether the received NM message includes the PN request information that matches the cluster to which the corresponding lower layer ECU 50, 60, 70 and the actuator 80, 85 belong. Then, when each communication IF 52, 62, 72, 84, 89 determines that the received NM message includes the PN request information that matches the cluster to which the corresponding lower layer ECU 50, 60, 70 and the actuator 80, 85 belong, the communication IF activates the corresponding lower layer ECU 50, 60, 70 and the corresponding actuator 80, 85 thereby switching to the operation states.

The communication IFs 52, 62, 72, 84, 89 of the first to third lower layer ECUs 50, 60, 70 and the first and second actuators 80, 85 do not necessarily have to support the partial networking function. In this case, when the communication IF 52, 62, 72, 84, 89 receives an NM message in the sleep state, the communication IF temporarily activate the processing unit of corresponding lower layer ECU 50, 60, 70 and the corresponding actuator 80, 85. The processing unit of the activated lower layer ECU 50, 60, 70 and the corresponding actuator 80, 85 may be configured to determine whether the NM message includes the PN request information that matches the cluster to which own device belongs.

When the processing unit of activated one of the first to third lower layer ECUs 50, 60, 70 and the first and second actuators 80, 85 determines that the NM message includes the PN request information that matches the cluster to which own device belongs, the operation state is maintained. When the processing unit of activated one of the first to third lower layer ECUs 50, 60, 70 and the first and second actuators 80, 85 determines that the NM message does not include the PN request information that matches the cluster to which own device belongs, the device returns to the sleep state.

In the present embodiment, the NM message transmitted by the upper layer ECU 10 or the like is received by the first to third lower layer ECUs 50, 60, 70 and the first and second actuators 80, 85. Then, the first to third lower layer ECUs 50, 60,70 and the first and second actuators 80, 85 each determines whether to switch to the operation state or maintain the sleep state based on the received NM message.

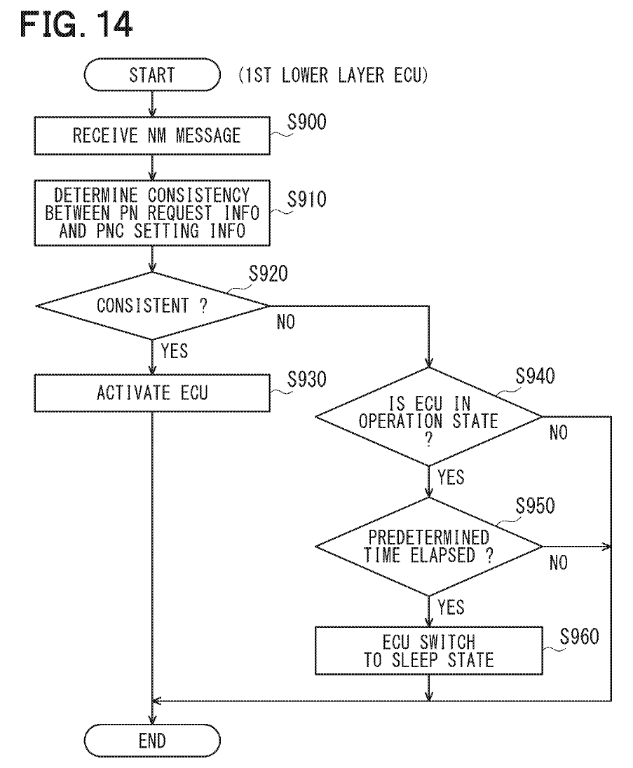

FIG. 14 is a flowchart showing an example of a process executed by the first to third lower layer ECUs 50, 60, 70. In the following description, the process shown in the flowchart of FIG. 14 will be described using the first lower layer ECU 50 as a representative example. The first lower layer ECU 50 periodically executes the process shown in the flowchart of FIG. 14.

In S900, the first lower layer ECU 50 receives the NM message via the communication IF 52. In S910, the first lower layer ECU 50 (or the communication IF 52, the same applies below) determines whether the activation target cluster requested to be activated by the PN request information in the received NM message matches or consistent to the cluster set in the PNC setting information of own ECU.

In S920, the first lower layer ECU 50 determines, based on the determination result of S910, whether the activation target cluster defined by the PN request information of the NM message is consistent to the cluster defined by the PNC setting information set for own ECU 50. In response to determining matching success, the first lower layer ECU 50 proceeds to S930. In response to determining matching failure, the first lower layer ECU 50 proceeds to S940.

In S930, the communication IF 52 activates the first lower layer ECU 50, or the first lower layer ECU 50 maintains the operation state if the lower layer ECU 50 has been activated. As a result, the first lower layer ECU 50 is switched to the operation state. In S940, the first layer ECU 50 determines whether own ECU has been activated and in the operation state. In response to determining that the first lower layer ECU 50 is in the operation state, the first lower layer ECU 50 proceeds to S950. In response to determining that the first lower layer ECU 50 is not in the operation state, the first lower layer ECU 50 ends the process shown in the flowchart of FIG. 14.

In S950, the first lower layer ECU 50 determines whether a predetermined period of time has elapsed since last reception of NM messages, which includes the PN request information designating the cluster to which the first lower layer ECU 50 belongs as the activation target cluster. In response to determining that the predetermined period of time has elapsed, the first lower layer ECU 50 proceeds to S960. In response to determining that the predetermined period of time not yet elapsed, the first lower layer ECU 50 ends the process shown in the flowchart of FIG. 14.

In S960, the first lower layer ECU 50 switches to the sleep state. In this sleep state, the first lower layer ECU 50 is only able to process the reception of NM messages, and stops other processes.

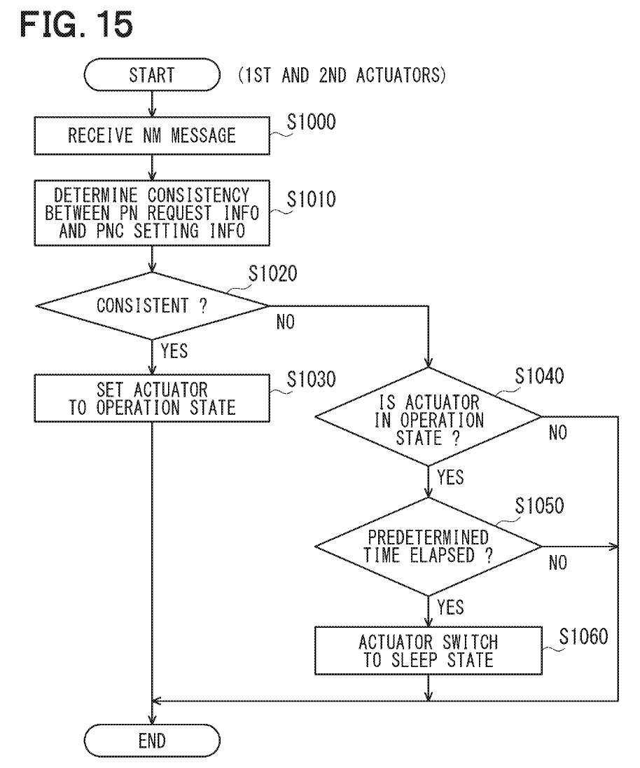

The flowchart of FIG. 15 will be described. As described above, each of the first and second actuators 80, 85 may include a processing unit having a processing function capable of receiving a message and performing an operation in accordance with a control instruction included in the message. The sensor may also include a processing unit having a processing function capable of generating and transmitting a message including information corresponding to the detected sensor signal. FIG. 15 is a flowchart showing an example of process executed by the processing units of the first and second actuators 80, 85 or the sensor. The first actuator 80 will be described as a representative example. The first actuator 80 periodically executes the process shown in the flowchart of FIG. 15.

In S1000, the processing unit of the first actuator 80 receives the NM message via the communication IF 84. Then, in S1010, the processing unit of the first actuator 80 determines whether the activation target cluster defined by the PN request information included in the received NM message matches or consistent to the cluster of the PNC setting information set for the first actuator 80.

In S1020, the processing unit of the first actuator 80 determines, based on the determination result of S1010, whether the activation target cluster defined by the PN request information of the received NM message is consistent to the cluster defined by the PNC setting information set for the actuator and/or sensor. In response to determining matching success, the first actuator 80 proceeds to S1030. In response to determining matching failure, the first actuator 80 proceeds to S1040.

In S1030, the processing unit of the first actuator 80 switches the first actuator 80 to the operation state. For example, the processing unit of the first actuator can switch the first actuator to the operation state according to a control instruction included in the message. Alternatively, a drive signal may be transmitted from the first lower layer ECU 50 to the first actuator 80. As a result, the first actuator 80 can be switched to the operation state and operate in response to an instruction from the first lower layer ECU 50.

In S1040, the processing unit of the first actuator 80 determines whether the first actuator 80 is in the operation state. In response to determining that the first actuator 80 is in the operation state, the processing unit of the first actuator 80 proceeds to S1050. In response to determining that the first actuator 80 is not in the operation state, the processing unit of the first actuator 80 ends the process shown in the flowchart of FIG. 15.

In S1050, the processing unit of the first actuator 80 determines whether a predetermined period of time has elapsed since last reception of the NM message, which includes the PN request information designating the activation target cluster as the cluster to which the first actuator 80 belongs. In response to determining that the predetermined period of time has elapsed, the first actuator 80 proceeds to S1060. In response to determining that the predetermined period of time not yet elapsed, the processing unit of the first actuator 80 ends the process shown in the flowchart of FIG. 15.

In S1060, the processing unit of the first actuator 80 controls the first actuator 80 to switch to the sleep state. In the sleep state, the processing unit of the first actuator 80 is only able to process the reception of NM messages, and all other stops other processes. Alternatively, a drive signal transmitted from the first lower layer ECU 50 may be configured to not received by the first actuator 80.

The process executed by the upper layer ECU 10 to transmit the NM message to activate the lower layer ECU when the first activation condition is satisfied, and to transmit the NM message to activate the actuator and/or sensor when the second activation condition is satisfied, is the same as the process shown in the flowchart of FIG. 5 of the first embodiment. The process of switching between the normal mode and the security mode executed by the upper layer ECU 10 is similar to the process shown in the flowchart of FIG. 6 of the first embodiment. Therefore, a description of the process executed by the upper layer ECU 10 will be omitted.

### Fifth Embodiment

The following will describe a vehicle system 200A according to a fifth embodiment of the present disclosure. The vehicle system 200A according to the present embodiment is configured similarly to the vehicle system 200A according to the fourth embodiment. Thus, detailed description of the same or similar configuration will be omitted.

In the present embodiment, in the vehicle system 200A, which is similar to the fourth embodiment, when the upper layer ECU 10 determines that the second activation condition is satisfied, the PNC setting information set for the actuator and/or sensor is changed to be the same as the PNC setting information set for the lower layer ECU as described in the second embodiment.

In the vehicle system 200A according to the present embodiment, the PNC setting information set for the actuator and/or sensor is stored in the processing units of the actuator and/or sensor. Therefore, when the upper layer ECU 10 attempts to change the PNC setting information of actuator and/or a sensor, the upper layer ECU instructs the processing unit of the actuator and/or sensor to change the PNC setting information. Upon receiving this changing instruction, the processing unit of the actuator and/or sensor changes the PNC setting information set for the actuator and/or sensor to be the same as the PNC setting information set for the lower layer ECU.

Alternatively, when the upper layer ECU 10 determines that the first activation condition is satisfied, the upper layer ECU 10 may change the PNC setting information set for the lower layer ECU to be the same as the PNC setting information set for the actuator and/or sensor. In this case, the lower layer ECU, together with the actuator and/or the sensor, is activated by the NM message transmitted from the upper layer ECU 10 in response to the second activation condition being satisfied.

When the upper layer ECU 10 attempts to change the PNC setting information of the lower layer ECU, the upper layer ECU 10 only needs to instruct the lower layer ECU to change the PNC setting information. Upon receiving this instruction, the lower layer ECU can change the PNC setting information set for own ECU so that the PNC setting information set for own ECU becomes the same as the PNC setting information set for the actuator and/or sensor.

As described above, the present embodiment differs from the second embodiment only in the entity that changes the actuator and/or sensor, or the PNC setting information of the lower layer ECU. The process executed by the upper layer ECU 10 is substantially the same as the process shown in the flowchart of FIG. 9. Therefore, description of remaining configuration will be omitted.

### Modifications

The present disclosure is not limited to the above-described embodiments. In addition to the above-described embodiments, the present disclosure can be implemented in various modifications within the scope of the spirit of the present disclosure.

### First Modification

The lower layer ECU and an actuator and/or a sensor that operate in cooperative manner, the method for activating the lower layer ECU and the method for activating the actuator and/or the sensor do not have to be the same as the activation method described in each embodiment. For example, the method for activating the lower layer ECU and the method for activating the actuator and/or sensor may be different methods from the methods described in the above embodiments of the present disclosure.

### Second Modification

When the vehicle system 200 according to the present disclosure is applied to the application of locking or unlocking vehicle doors, and a third party gets into the vehicle without following the proper security unlock procedure, for example, by breaking the window glass, the vehicle system 200 may notify each ECU of the vehicle that the vehicle theft is occurred. In this case, each ECU of the vehicle may, for example, notify the cloud server 400 of the position of vehicle specified by the positioning device. Further, the ECU constituting the vehicle propulsion control system may set the vehicle in an evacuation travel mode and limit the vehicle's travel speed and travel distance.

### Third Modification

The systems and methods described in the present disclosure may be implemented by a special purpose computer comprising a processor programmed to perform one or more functions embodied in a computer program. The systems and methods described in the present disclosure may be implemented using dedicated hardware logic circuitry. The systems and methods described in the present disclosure may be implemented by one or more special purpose computers comprising a combination of a processor executing a computer program and one or more hardware logic circuits. For example, some or all of the functions of the upper layer ECU 10, the first to third intermediate layer ECUs 20, 30, 40, the first to third lower layer ECUs 50, 60, 70, and the processing units of the actuator and/or sensor may be implemented by hardware circuits. A configuration in which a certain function is implemented by hardware logic circuitry includes a configuration in which the function is implemented using one or more ICs or the like. For example, some or all of the functions of the upper layer ECU 10, the first to third intermediate layer ECUs 20, 30, 40, the first to third lower layer ECUs 50, 60, 70, and the processing units of the actuator and/or sensor may be implemented using any of a system-on-chip (SoC), an integrated circuit (IC), and a field-programmable gate array (FPGA). The concept of IC includes ASIC (Application Specific Integrated Circuits). The computer program described above may be stored in a computer-readable non-transitory tangible storage medium as instructions to be executed by a computer. As a storage medium for storing the computer program, a hard disk drive (i.e., HDD), a solid state drive (i.e., SSD), a flash memory, or the like can be adopted. The scope of the present disclosure also includes programs for causing a computer to function as the processing units of the upper layer ECU 10, the first to third intermediate layer ECUs 20, 30, 40, the first to third lower layer ECUs 50, 60, 70, and actuator and/or sensor, as well as non-transitory tangible storage medium, such as semiconductor memories on which programs are recorded.

What is claimed is:

1. A vehicle system comprising:
a management target control device configured to be activated and switched to an operable state in response to a first activation condition being satisfied; and
a management target device including at least one of an actuator or a sensor, the management target device being configured to be activated in response to a second activation condition being satisfied,
wherein
the second activation condition is set to be different from the first activation condition,
the actuator is configured to operate in response to an instruction from the management target control device,
the sensor is configured to provide a sensor signal necessary for a control process to be executed by the management target control device, and
the management target control device and the management target device operate in cooperative manner to allow a user to board a vehicle or to operate the vehicle.

2. The vehicle system according to claim 1, wherein
the management target control device has cluster setting information indicating a cluster to which the management target control device belongs among multiple clusters divided in advance,
the management target control device is activated in response to the first activation condition being satisfied and reception of an activation message from another control device, and
the activation message indicates the cluster to which the management target control device belongs as an activation target cluster.

3. The vehicle system according to claim 1, further comprising
a first upper layer control device configured to control power supply to the management target control device,
wherein, in response to the first activation condition being satisfied, the first upper layer control device starts the power supply to the management target control device to activate the management target control device.

4. The vehicle system according to claim 1, further comprising
a first upper layer control device configured to control power supply to the management target control device,
wherein
the first upper layer control device has cluster setting information indicating a cluster to which the management target control device belongs among multiple clusters divided in advance,
the first upper layer control device starts the power supply to the management target control device in response to the first activation condition being satisfied and reception of an activation message from another control device, and
the activation message indicates the cluster to which the management target control device belongs as an activation target cluster.

5. The vehicle system according to claim 2, wherein
the management target device has cluster setting information indicating a cluster to which the management target device belongs among the multiple clusters divided in advance,
the cluster to which the management target device belongs is set to be different from the cluster to which the management target control device belongs,
the management target device is activated in response to the second activation condition being satisfied and reception of an activation message from another control device, and
the activation message indicates the cluster to which the management target device belongs as the activation target cluster.

6. The vehicle system according to claim 2, further comprising
a second upper layer control device configured to control power supply to the management target device,
wherein the second upper layer control device starts the power supply to the management target device to activate the management target device in response to the second activation condition being satisfied.

7. The vehicle system according to claim 2, further comprising
a second upper layer control device configured to control power supply to the management target device,
wherein
the second upper layer control device has cluster setting information indicating a cluster to which the management target device belongs among the multiple clusters divided in advance,
the cluster to which the management target device belongs is set to be different from the cluster to which the management target control device belongs,
the second upper layer control device starts the power supply to the management target device in response to the second activation condition being satisfied and reception of an activation message from another control device, and
the activation message indicates the cluster to which the management target device belongs as the activation target cluster.

8. The vehicle system according to claim 1, wherein
the management target control device has cluster setting information indicating a cluster to which the management target control device belongs among multiple clusters divided in advance,
the management target device has cluster setting information indicating a cluster to which the management target device belongs among the multiple clusters divided in advance,
the cluster to which the management target device belongs is set to be different from the cluster to which the management target control device belongs,
the cluster setting information of the management target control device is changed to belong to the same cluster as the cluster to which the management target device belongs in response to the first activation condition being satisfied, or the cluster setting information of the management target device is changed to belong to the same cluster to which the management target control device belongs in response to the second activation condition being satisfied, and
the management target control device and the management target device are activated in response to reception of a same activation message.

9. The vehicle system according to claim 1, further comprising
a first upper layer control device configured to control power supply to the management target control device; and
a second upper layer control device configured to control power supply to the management target device,
wherein
the first upper layer control device has cluster setting information indicating a cluster to which the management target control device belongs among multiple clusters divided in advance,
the second upper layer control device has cluster setting information indicating a cluster to which the management target device belongs among the multiple clusters divided in advance,
the cluster to which the management target device belongs is set to be different from the cluster to which the management target control device belongs,
the first upper layer control device changes the cluster setting information of the management target control device so that the cluster to which the management target control device belongs becomes the same as the cluster to which the management target device belongs in response to the first activation condition being satisfied, or the second upper layer control device changes the cluster setting information of the management target device so that the cluster to which the management target device belongs becomes the same as the cluster to which the management target control device belongs in response to the second activation condition being satisfied, and
the first upper layer control device starts the power supply to the management target control device and the second upper layer control device starts the power supply to the management target device, in response to reception of a same activation message.

10. The vehicle system according to claim 5, further comprising
a changing unit configured to change the cluster setting information so that the cluster to which the management target control device belongs differs from the cluster to which the management target device belongs in response to a predetermined switch condition for switching to a security mode being satisfied.

11. The vehicle system according to claim 10, wherein
the predetermined switch condition for switching to the security mode is satisfied (i) when a user performs an operation for switching to the security mode or (ii) when parking of the vehicle in a specific area is detected.

12. The vehicle system according to claim 1, wherein
one of the first activation condition or the second activation condition is satisfied when a predetermined operation is performed by the user using a mobile device carried by the user.

13. The vehicle system according to claim 12, wherein
the predetermined operation performed using the mobile device is a start instruction of an application installed in a portable information terminal serving as the mobile device.

14. The vehicle system according to claim 12, wherein
the predetermined operation performed using the mobile device is locating the mobile device at a position where a short-range wireless communication can be performed between the mobile device and the vehicle.

15. The vehicle system according to claim 12, wherein
the predetermined operation performed using the mobile device is an unlocking operation using a physical key serving as the mobile device.

16. A control method of a vehicle system, the control method comprising:
activating a management target control device and switching the management target control device to an operable state, in response to a first activation condition being satisfied; and
activating a management target device, which includes at least one of an actuator or a sensor, in response to a second activation condition being satisfied,
wherein
the second activation condition is set to be different from the first activation condition,
the actuator is configured to operate in response to an instruction from the management target control device,
the sensor is configured to provide a sensor signal necessary for a control process to be executed by the management target control device, and
the management target control device and the management target device operate in cooperative manner to allow a user to board a vehicle or to operate the vehicle.
